(19) United States
(12) Patent Application Publication
(10) Pub. No.: US 2014/0231104 A1
(43) Pub. Date: Aug. 21, 2014

(54) Fire Truck Capable Of Rapid High-Rise Rescues

(71) Applicant: Lipeng You, Putian City (CN)

(72) Inventor: Lipeng You, Putian City (CN)

(21) Appl. No.: 14/129,398

(22) PCT Filed: Jun. 28, 2012
(86) PCT No.: PCT/CN2012/077714

§ 371 Date: Apr. 2, 2014

(30) Foreign Application Priority Data
Jun. 29, 2011 (CN) 201110178891.6

(51) Int. Cl. A62C 27/00; A62B 1/20

(52) U.S. Cl. CPC A62C 27/00; A62B 1/20
USPC 169/24

(57) ABSTRACT

Disclosed is a fire truck capable of performing rapid rescues from high-rise buildings, comprising a vehicle body (1), a cantilever (2) or a scaling ladder installed on the vehicle body (1), and an operation platform (3) installed on an upper end of the cantilever (2) or the scaling ladder. wherein a water tank (4) is provide on the rear carriage of the vehicle body (1), a top wall of the water tank (4) is made of an elastic material; a chute (5) connects a top wall of the water tank (4) and the operation platform (3), a wall of the chute (5) is made of a material which is flexible and has elasticity and ductility; a bottom of the chute (5) is at the middle position of the top wall of the water tank (4); a lower part of the wall of the chute (5) is provided with an exit (6); and an entrance (7) is provided at the top end of the chute (5). The fire truck of the present invention not only has all firefighting features of the conventional fire truck, but can also rapidly and conveniently carry people in need of rescue from high-rises down to the ground, thereby substantially reducing loss of life and property damage.

### FIELD OF THE INVENTION

The present invention is related to a fire truck capable of performing rapid rescues from high-rise buildings.

### DESCRIPTION OF THE PRIOR ART

The current existing fire truck mainly uses a scaling ladder for climbing when performing high-rise extinguishing and rescue work. Firefighters rescue people who need to be rescued from high-rise and carry them from a door, window or balcony to the ground by means of the scaling ladder. The rescue speed of the whole process is slow, and it is dangerous for carrying the elderly, children, timid women and obese people because the current scaling ladder lacks effective safety protection, which also influences the rescue speed. Especially when there are many people who need to be rescued, because of the slow rescue speed, this generally leads to many unnecessary casualties and loss.

### SUMMARY OF THE INVENTION

In order to solve the above-mentioned problems existing in the prior art, the present invention provides a fire truck capable of performing rapid rescues from high-rise buildings. It not only has the function of firefighting which the regular fire truck has, but also can conveniently and rapidly carry people who need to be rescued from high-rise to the ground, thereby largely reducing the loss of life and properties.

The technical solution of the present invention is: a fire truck capable of performing rapid rescues from high-rise buildings comprises a vehicle body, a cantilever or a scaling ladder which is installed on the vehicle body, and an operation platform which is installed on an upper end of the cantilever or the scaling ladder; the vehicle body is provided with an elastic buffer device, and a chute which is capable of extending, retracting and being out of shape between the elastic buffer device and the operation platform with the operation platform going up and down connects the elastic buffer device and the operation platform; a lower part of a wall of the chute is provided with an exit; an entrance is provided at the top of the chute.

A cable which is hung in the chute extends from the entrance to the exit and the cable is provided with more than one descent control device. The descent control device can adopt the ones dedicated to climb or be called as slow speed device. The rescued one can slide down along the chute by pulling the descent control device, thereby controlling the sliding speed. The descent control device can also adopt various existing tools capable of sliding down along the cable and having the function of reducing speed.

The elastic buffer device comprises a water tank, a top wall of the water tank is made of an elastic material, and a bottom of the chute is attached to a middle part of the top wall of the water tank (it is not limited to the exact middle position, and as long as it is not at the edge).

The side wall of the water tank is preferably made of an elastic material. Thus, the whole water tank forms similarly saccate shape. The top of the water tank can go up and down with the water level of the water tank. The impact force occured when the rescued people sliding down can be largely reduced by the buffer produced by the water, so that the sliding speed is effectively buffered and reduced.

For preferred embodiment, the elastic buffer device can adopt various devices having the function of elastic buffer for falling objects such as rubber pad, foam pad or cushion and so on.

In the above-mentioned technical solutions of the present invention, in order to make the chute connected between the elastic buffer device and the operation platform be capable of extending, retracting and being out of shape between the elastic buffer device and the operation platform with the operation platform going up and down, the chute can use the following different structures: (I) Structure I: the wall of the chute adopts a material which is flexible and has elasticity and ductility, for example, a middle-upper part of the wall of the chute has a shape of a bellows, and a lower part of the wall of the chute, which is provided with the exit, has a shape of tube, to ensure that the exit of the lower part of the chute is open, thus the chute can extend and retract with the operation platform going up arid down to adapt to different rescue heights. When the rescued people enter into the chute, the chute is pressed by the weight of rescued people, and the middle part of the chute may bend and be out of shape (the extent of bending is different and may not exist according to the material of the chute). During the manufacturing, only making the bending part of the chute after being out of shape with no more than rated load always higher than the bottom of the chute by selecting the chute having suitable deformation ability, it can be ensured that rescued people can reach the elastic buffer device through the chute and not fall to the places other than the elastic buffer device in the midway. (II) Structure II: the chute is made by successively connecting a plurality of telescopic pipes which can extend and retract relative to each other, and various telescopic pipes stretch and move with the operation platform going up and down, which forms the passage for rescued people sliding from top to down. Moreover, the chute can also use various other existing structures capable of directing the rescued people to chute and stretching and being out of shape.

In order to make it easy for people to enter into the chute, the entrance is provided on the operation platform and preferably on the front corner and bottom of the operation platform.

Moreover, the exit is preferably in the direction perpendicular to the sliding direction of the chute and parallel to the ground. Thus, when people sliding down along the chute reach the bottom of the chute, they will not directly go out of the chute and they will be buffered and stop by the cooperation and buffer of the top wall of the water tank and the chute and go out of the chute from the exit. Certainly, the exit is not necessarily to be provided in the direction perpendicular to the sliding direction of the chute and parallel to the ground. During the specific performing, the exit can be provided at any position around the bottom of the chute, and if it is not provided at the position along the sliding direction, rescued people will not directly go out of the chute.

The sliding direction of the chute is preferably at an oblique angle to the ground, in other words, with an acute angle. No matter how high the operation platform goes up, the chute connected between the operation platform and elastic buffer device is always at an oblique angle to the ground. This is beneficial to that rescued people slide down along the chute with reducing speed rather than directly vertically drop.

In order to further improve the effect of buffer and reducing speed, the top wall of the water tank can be a sealed double-layer structure and the interlayer of the double-layer structure is filled with gas. This can not only plays a better buffer effect than water, but also still has the function of buffer protection after the water in the water tank runs out.

The above-mentioned technical solutions of the invention have the working principle illustrated as follows: when an accident occurs in the high-rise and rescue is needed, a fire truck capable of rapidly performing high-rise rescue said in the present invention is driven to the side of high-rise, and the cantilever is used to lift the operation platform to the side of the floor which needs rescue work and stop it. If necessary, the cutting tool equipped on the operation platform can be used to firstly cut the obstacles such as security mesh. If not necessary, the firefighter can carry water gun equipped on the operation platform, directly enter the corresponding floor to put out a fire, find trapped people, carry people who need to be rescued to the operation platform, and make them enter into the chute from the entrance of the chute and slide to the bottom along the chute. Because the bottom of the chute is arranged with the water tank, and the side wall and the top wall of the water tank are made of elastic material, when the water tank is tilled with water and the filled water is not too full, the top wall of the water tank can play a better function of elastic buffer and reducing speed :for people dropping to it and it makes people sliding along the chute reduce speed and climb out of the exit. If necessary, the exit of the chute can also be arranged with personnel who help people sliding along the chute climb out. On the other hand, the water of the water tank can also be used for firefighting. compared with the prior art, the present invention has the following advantages:(1) The present invention can conveniently and rapidly carry people who need rescue on the high-rise to the ground, thereby largely improving rescue speed and reducing the loss of people.

(2) Because the wall of the chute is made of a material which is flexible and has elasticity and ductility, this not only prevents people who slide along the chute from being injured, but also adapts to stretching and deformation according to different rescue heights.

(3) Because the water tank is used as buffer tool for people to slide thereon, and the side wall and top wall of the water tank are made of elastic material, this can play better function of elastic buffer and reducing speed for people sliding along the chute to it and can use the water in the water tank for firefighting at the same time, which has double benefit effect.

### BRIEF DESCRIPTION OF THE DRAWINGS

FIG. 1 is a schematic diagram of the structure in an embodiment of the present invention.

FIG. 2 is a Direction A View of FIG. 1.

The illustration of the numbers in the figures: 1 vehicle body, 2 cantilever, 3 operation platform, 4 water tank, 5 chute, 6 exit, 7 entrance, 8 cable, 9 descent control device.

### DETAILED DESCRIPTION OF THE PREFERRED EMBODIMENTS

The content of the present invention is explained in details in combination with the drawings and the preferred embodiments as follows.

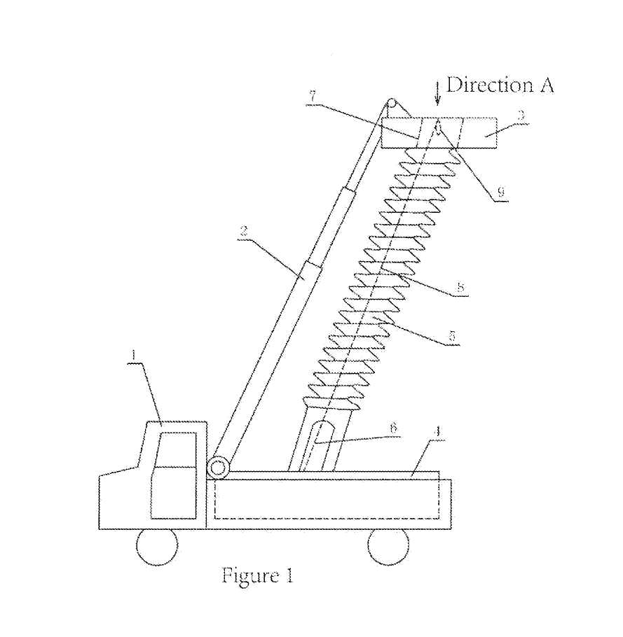

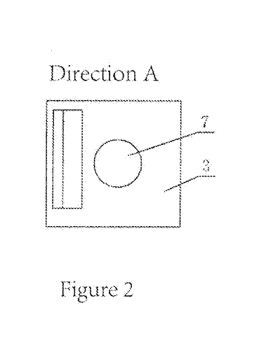

As shown in FIG. 1 and FIG. 2, the present invention provides a fire truck capable of performing rapid rescues from high-rise buildings. It comprises a vehicle body 1, a cantilever 2 or a scaling ladder which is installed on the vehicle body 1, and an operation platform 3 which is installed on an upper end of the cantilever 2 or the scaling ladder; wherein the vehicle body is provided with an elastic buffer device, and a chute which is capable of extending, retracting and being out of shape between the elastic buffer device and the operation platform with the operation platform 3 going up and down connects the elastic buffer device and the operation platform; a lower part of a wall of the chute 5 is provided with an exit 6; an entrance 7 is provided at the top of the chute 5.

A cable 8 which is hung in the chute 5 extends from the entrance 7 to the exit 6 and the cable 8 is provided with more than one descent control device 9.

As shown in FIG. 1, the elastic buffer device comprises a water tank 4, a top wall of the water tank 4 is made of an elastic material, and a bottom of the chute 5 is attached to a middle part of the top wall of the water tank 4,

The side wall of the water tank 4 preferably comprises an elastic material.

The wall of the chute 5 comprises a material which is flexible and has elasticity and ductility. For example, a middle-upper part of the wall of the chute 5 have a shape of a bellows, and the lower part of the wall of the chute 5, which is provided with the exit 6, has a shape of a tube.

Alternatively, the chute 5 is made by successively connecting plurality of telescopic pipes which can extend and retract relative to each other.

The entrance 7 is provided on the operation platform 3.

The exit 6 is located in a direction which is perpendicular to a sliding, direction of the chute 5 and parallel to the ground.

For avoiding a sliding speed which is too rapid, the sliding direction of the chute 5 is at an oblique angle to the ground.

The operation platform 3 is provided with a control device for operating and controlling upward, downward, leftward and rightward swinging movements or extending and retracting adjustment of the cantilever 2 or the scaling ladder, and rescue equipment needed for performing rescues; the rescue equipment comprises at least one of spray guns. cutting tools, hydraulic pliers, hydraulic expanders, lighting tools, and certainly can also comprise other existing various rescue equipment; the cantilever 2 or the scaling ladder is provided with a water channel for carrying water stored in the water tank 4 to the operation platform 3 and connecting lines for connecting the control device and a part or all of the rescue equipment to the vehicle body 1.

A control room of the vehicle body 1 can also be provided with a control device for operating and controlling upward, downward, leftward and rightward swinging movements or extending and retracting adjustment of the cantilever 2 according to needs.

The top wall of the water tank 4 comprises a sealed double-layer structure and an interlayer of the double-layer structure is filled with gas.

The cantilever 2 or the scaling ladder comprises an extending-retracting and swinging mechanism capable of adjustment of upward, downward leftward and rightward swinging movements and adjustment of extending and retracting relative to the vehicle body I the operation platform 3 is capable of keeping a horizontal working state relative to the cantilever 2 or the scaling ladder.

1. A fire truck capable of performing rapid rescues from high-rise buildings, which comprises a vehicle body (1), a cantilever (2) or a scaling ladder which is installed on the vehicle body (1), and an operation platform (3) which is installed on an upper end of the cantilever (2) or the scaling ladder; wherein the vehicle body is provided with an elastic buffer device, and a chute which is capable of extending, retracting and being out of shape between the elastic buffer device and the operation platform with the operation platform (3) going up and down connects the elastic buffer device and the operation platform; a lower part of a wall of the chute (5) is provided with an exit (6); an entrance (7) is provided at the top of the chute (5).

2. A fire truck capable of performing rapid rescues from high-rise buildings according to claim 1, wherein a cable (8) which is hung in the chute (5) extends from the entrance (7) to the exit (6) and the cable (8) is provided with more than one descent control device (9).

3. A fire truck capable of performing rapid rescues from high-rise buildings according to claim 1, wherein the elastic buffer device comprises a water tank (4), a top wall of the water tank (4) is made of an elastic material, and a bottom of the chute (5) is attached to a middle part of the top all of the water tank (4).

4. A fire truck capable of performing rapid rescues from high-rise buildings according to claim 3, wherein a side wall of the water tank (4) comprises an elastic material.

5. A fire truck capable of performing rapid rescues from high-rise buildings according to claim 1, wherein the wall of the chute (5) comprises a material which is flexible and has elasticity and ductility.

6. A fire truck capable of performing rapid rescues from high-rise buildings according to claim 5, wherein a middle-upper part of the wail of the chute (5) have a shape of a bellows and the lower part of the all of the chute (5), which is provided with the exit (6). has a shape of a tube.

7. A fire truck capable of performing rapid rescues from high-rise buildings according to claim 3, wherein the wall of the chute (5) comprises a material which is flexible and has elasticity and ductility.

8. A fire truck capable of rapidly performing high-rise rescue according to claim 1 or, wherein the chute (5) is made by successively connecting a plurality of telescopic pipes which can extend and retract relative to each other.

9. A fire truck capable of performing rapid rescues from high-rise buildings according to claim 1, wherein the entrance (7) is provided on the operation platform (3).

10. A fire truck capable of performing rapid rescues from high-rise buildings according to claim 1, wherein the exit (6) is located in a direction which is perpendicular to a sliding direction of the chute (5) and parallel to the ground.

11. A fire truck capable of performing rapid rescues from high-rise buildings according to claim 1, wherein the sliding direction of the chute (5) is at an oblique angle to the ground.

12. A fire truck capable of performing rapid rescues from high-rise buildings according to claim 3, wherein the operation platform (3) is provided with a control device for operating and controlling upward, downward, leftward and rightward swinging movements or extending and retracting adjustment of the cantilever (2) or the scaling ladder, and rescue equipment needed for performing rescues, the rescue equipment comprises at least one of spray guns, cutting tools, hydraulic pliers, hydraulic expanders, lighting tools; the cantilever (2) or the scaling ladder is provided with a water channel for carrying water stored in the water tank (4) to the operation platform (3) and connecting lines for connecting the control device and a part or all of the rescue equipment to the vehicle body (1).

13. A fire truck capable of performing rapid rescues from high-rise buildings according to claim 3, wherein the top wall of the water tank (4) comprises a of sealed double -laver structure and an interlayer of the double-laver structure is filled with gas.

14. A fire truck capable of performing rapid rescues from high-rise buildings according to claim 1, wherein the cantilever (2) or the scaling ladder comprises an extending-retracting and swinging mechanism capable of adjustment of upward, downward, leftward and rightward swinging movements and adjustment of extending and retracting relative to the vehicle body (1); the operation platform (3) is capable of keeping a horizontal working state relative to the cantilever (2) or the scaling ladder.

15. A fire truck capable of performing rapid rescues from high-rise buildings according to claim 2, wherein the elastic buffer device comprises a water tank (4), a top wall of the water tank (4) is made of an elastic material, and a bottom of the chute (5) is attached to a middle part of the top wall of the water tank (4).

16. A fire truck capable of performing rapid rescues from high-rise buildings according to claim 1, wherein the wall of the chute (5) comprises a material which is flexible and has elasticity and ductility.

17. A fire truck capable of rapidly performing high-rise rescue according to claim 2, wherein the chute (5) is made by successively connecting a plurality of telescopic pipes which can extend and retract relative to each other.

18. A fire truck capable of performing rapid rescues from high-rise buildings according to claim 2, wherein the entrance (7) is provided on the operation platform (3).

19. A fire truck capable of performing rapid rescues from high-rise buildings according to claim 2, wherein the exit (6) is located in a direction which is perpendicular to a sliding direction of the chute (5) and parallel to the ground.

20. A fire truck capable of performing rapid rescues from high-rise buildings according to claim 2, wherein the sliding direction of the chute (5) is at an oblique angle to the ground.
